(19) United States
(12) Patent Application Publication
(10) Pub. No.: US 2008/0225079 A1
(43) Pub. Date: Sep. 18, 2008

(54) Printing machine and cleaning method

(75) Inventor: Shr-How Haung, Taoyuan County (TW)

Correspondence Address: BIRCH STEWART KOLASCH & BIRCH, PO BOX 747, FALLS CHURCH, VA, 22040-0747, US

(73) Assignee: Qisda Corporation

(21) Appl. No.: 12/076,081

(22) Filed: Mar. 13, 2008

(30) Foreign Application Priority Data
Mar. 16, 2007 (TW) 96109190

(51) Int. Cl. B41J 2/165

(52) U.S. Cl. 347/33

(57) ABSTRACT

A printer with the inkjet heads comprises a slideway, a printing mechanism and a maintaining mechanism. The printing mechanism comprises a first inkjet cartridge, a second inkjet cartridge, a first container, and a second container. The second inkjet cartridge has a driving mechanism. The maintaining mechanism comprises a first scraper, a second scraper, a sled and a clutch. When the driving mechanism activates the sled, the sled then drives the scrapers to the cleaning position so as to clean the inkjet heads, respectively, and when the printing mechanism activates the clutch in order to control the sled to drive the scrapers to leave the wiping position.

This application claims the benefit of Taiwan Patent Application Serial No. 096109190 filed on Mar. 16, 2007, the subject matter of which is incorporated herein by reference.

### BACKGROUND OF THE INVENTION

(1) Field of the Invention

The invention relates to a printing machine, and more particularly to a printing machine that can clean and protect the inkjet heads thereof.

(2) Description of the Prior Art

Nowadays printing machines are important in our life. Information, characters, pictures, and photos, can be printed out. The printing machines including inkject printer, fax machine, copier, etc., have been widely applied with the matters of cleaning the inkjet head and the maintaining mechanism and the relations for printing quality.

A printing machine comprises: a slideway, a printing mechanism, and a maintaining mechanism. Wherein the printing mechanism comprises: a first container for accommodating a first inkjet cartridge and sliding along the slideway, and a second container for accommodating a second inkjet cartridge and sliding along the slideway. The maintaining mechanism comprises: a first scraper for cleaning one inkjet head with a first width within the first inkjet cartridge, and a second scraper for cleaning another inkjet head with a second width within the second inkjet cartridge.

Scrapers of the conventional maintaining mechanism move in two directions for cleaning. One parallel to the direction of the arrangement of the inkjet openings, and the other is perpendicular.

Referred to FIG. 1a, which illustrates a schematic view of the cleaning direction of the scrapers parallel to the direction of the inkjet openings. The maintaining mechanism 100 includes a first scraper 111 and a second scraper 121. The two scrapers are arranged along the D2 direction, but the direction of cleaning is along the D1 direction. The printing mechanism has an inkjet cartridge 110 having an inkjet head with a first width X1, and an inkjet cartridge 120 having an inkjet head with a second width X2. Referring to FIG. 1b, two UV rubber bands 130 are under the inkjet cartridge 110, and the distance of the two UV rubber bands 130 is equal to the first width X1. Referring to FIG. 1c, two UV rubber bands 130 are under the inkjet cartridge 120 as well, and the distance of the two UV rubber band 130 is equal to the second width X2. While cleaning, the cleaning direction (D1) of the scrapers is parallel to the direction (D1) of the arrangement of the inkjet openings of the inkjet cartridges 110, 120.

However, the cleaning direction (D1) of scrapers parallel to the direction (D1) of the arrangement of the inkjet openings of the inkjet cartridges 110, 120 should be to arrange the maintaining mechanism 100 at different sections for the inkjet cartridges 110, 120. So that the space for the inkjet cartriages 110, 120 may be larger, and therefore the cost is higher. Furthermore, such arrangement may cause more power due to larger diameters and higher torque.

The other moving type of a conventional maintaining mechanism is described as below. Referring to FIG. 2a, which illustrates a schematic top view of the cleaning direction of scrapers perpendicular to the direction of the arrangement of the inkjet openings. The maintaining mechanism 200 comprises a first scraper 211 and a second scraper 221. The two scrapers are arranged along the D2 direction, but the direction of cleaning is along along the D2 direction. The printing mechanism comprises an inkjet cartridge 210 having an inkjet head with a first width X1, and an inkjet cartridge 220 having an inkjet head with a second width X2. Referring to FIG. 2b, two UV rubber bands 230 are under the inkjet cartridge 210, and the distance of the two UV rubber bands 230 is equal to the first width X1. Referring to FIG. 2c, two UV rubber band 230 are under the inkjet cartridge 220, and the distance of the two UV rubber bands 230 is equal to the second width X2. While cleaning, the cleaning direction (D2) of the scrapers is perpendicular to the direction (D1) of the arrangement of the inkjet openings of the inkjet cartridges 110, 120.

However, while the printing mechanism uses the inkjet cartridge 210 having an inkjet head with the first width X1 and the inkjet cartridge 240 having an inkjet head with the first width X1, the second scraper 221 will be blocked by the two UV rubber bands 230 because of the narrower width of the inkjet head with the first width X1. Referring to FIG. 2d, which illustrates a schematic front view of a second scraper not cleaning the inkjet openings of the inkjet cartridge in prior arts. The second scraper 221 can not clean the inkjet openings of the inkjet cartridge 240 effectively so as to cause worse printing quality.

Therefore, a solution to resolve the aforesaid problem in power consumption and cleaning efficiency of the printing machine is definitely an important issue to the skilled persons in the art.

### SUMMARY OF THE INVENTION

Accordingly, the primary object of the present invention to provide a printing machine capable of cleaning and protecting the inkjet heads in order to save power, occupying space, and promote printing quality.

The printing machine comprises: a slideway, a printing mechanism, and a maintaining mechanism. Wherein the printing mechanism comprises: a first inkjet cartridge, a second inkjet cartridge, a first container, and a second container. The maintaining mechanism comprises: a first scraper, a second scraper, a sled, and a clutch.

The first inkjet cartridge is set in the first container and the second inkjet cartridge is set in the second container. The two containers slide along the slideway in forward and backward direction. The first scraper is used to clean an inkjet head with a first width and the second scraper is used to clean an inkjet head with a second width. The sled respectively connects with the bottoms of the first scraper and the second scraper, and elongates below the end of the slideway. The first scraper and the second scraper are driven to the cleaning position by the driving mechanism. The clutch connects with the sled at outside of the maintaining mechanism. The second inkjet cartridge has a driving mechanism, which drives the sled to control the first scraper and the second scraper to leave the cleaning position.

While the first inkjet cartridge has the inkjet head with the first width, the second inkjet cartridge has the inkjet head with the second width, and the two containers slide along the slideway to the end of the route in a forward direction, the second container drives the sled, then the sled drives the first scraper and the second scraper to the cleaning position. While the printing mechanism slides in a backward direction, the first scraper cleans the inkjet head with the first width of the first inkjet cartridge, and the second scraper cleans the inkjet head with the second width of the second inkjet cartridge. Then, the driving mechanism drives the clutch in order to control the first scraper and the second scraper to leave the cleaning position and stop cleaning.

While the first inkjet cartridge has the inkjet head with the first width, the second inkjet cartridge has the inkjet head with the second width, the moving steps are similar to foregoing. The only different part is that the driving mechanism of the second inkjet cartridge is set at the second position. After the first scraper cleaning the first inkjet cartridge and the second inkjet cartridge, the driving mechanism at the second position drives the clutch to make the sled control the two scrapers to stop cleaning. While the first inkjet cartridge has the inkjet head with the first width but without the second inkjet cartridge, the moving steps are similar to foregoing. The only different part is that after the first scraper cleaning the first inkjet cartridge, the edge of the second container drives the clutch to make the sled control the scrapers to stop cleaning.

### BRIEF DESCRIPTION OF THE DRAWINGS

The present invention will now be specified with reference to its preferred embodiment illustrated in the drawings, in which:

FIG. 1a illustrates a schematic view of a cleaning direction of scrapers parallel to a direction of inkjet openings in prior arts;

FIG. 1b illustrates a schematic front view of two UV rubber bands with a first width under an inkjet cartridge in prior arts;

FIG. 1c illustrates a schematic front view of two UV rubber band with a second width under the inkjet cartridge in prior arts;

FIG. 2a illustrates a schematic top view of a cleaning direction of scrapers perpendicular to a direction of an arrangement of inkjet openings in prior arts;

FIG. 2b illuminates a schematic front view of two UV rubber bands with the first width under the inkjet cartridge in prior arts;

FIG. 2c illustrates a schematic front view of the two UV rubber bands with the second width under the inkjet cartridge in prior arts;

FIG. 2d illustrates a schematic front view of a second scraper not cleaning the inkjet openings of the inkjet cartridge in prior arts;

FIG. 3a illustrates a partial schematic view of a printing machine of the present invention;

FIG. 3b illustrates a partial schematic view of a first preferred embodiment of the printing machine of the present invention;

FIG. 3c illustrates a partial schematic view of a second preferred embodiment of the printing machine of the present invention; and

FIG. 3d illustrates a partial schematic view of a third preferred embodiment of the printing machine of the present invention.

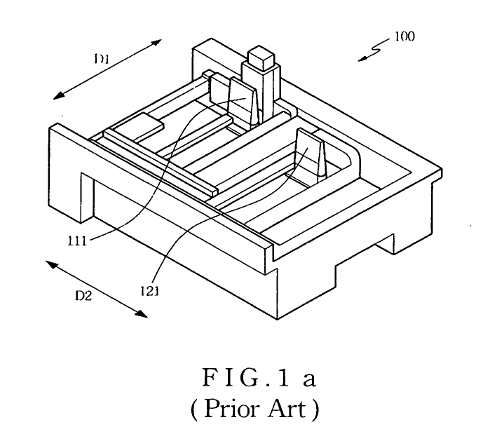

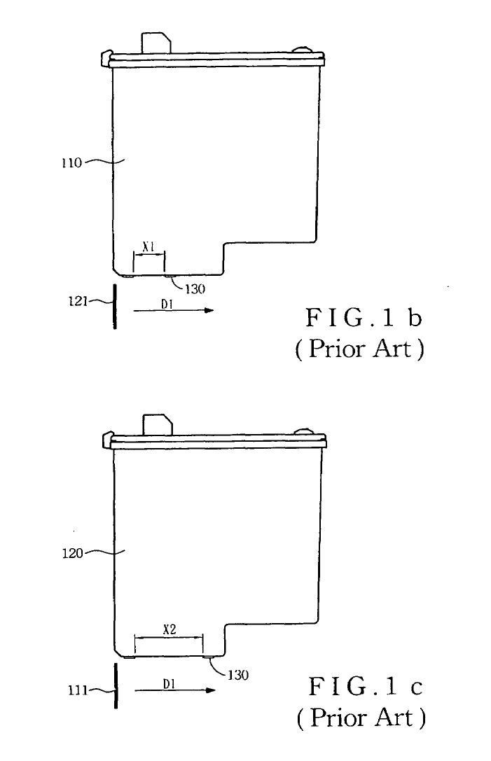

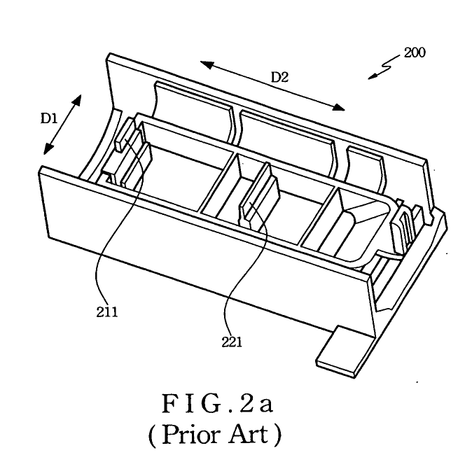

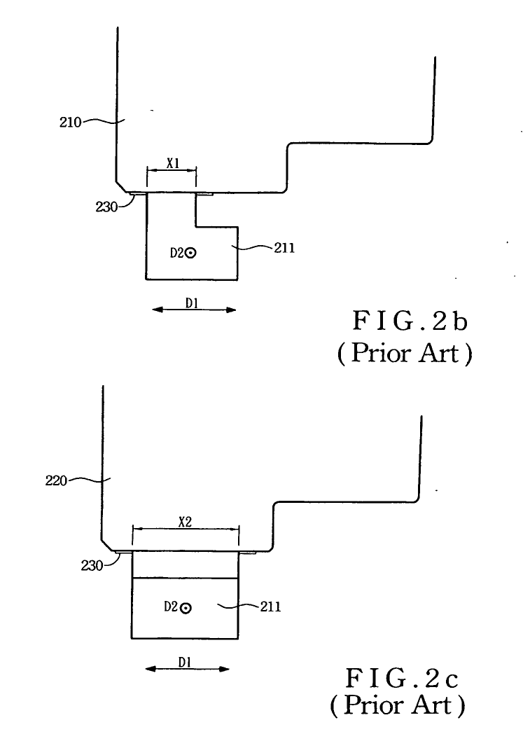

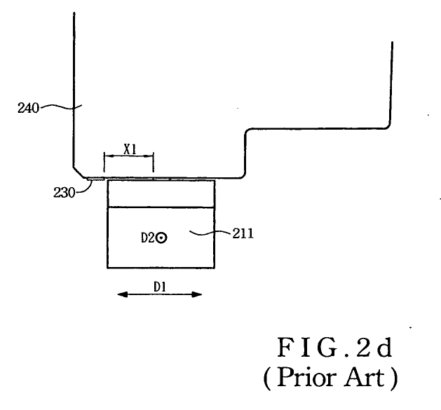

### DESCRIPTION OF THE PREFERRED EMBODIMENT

The invention disclosed herein is directed to a printing machine capable of cleaning and protecting inkjet heads and a cleaning method of using a maintaining mechanism of the printing machine. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the present invention, the printing machine effectively decreases the power of a motor, the space of the maintaining mechanism, the cost, and increases the efficiency of cleaning in order to improve the printing quality. Details of description about the present invention are as described below.

In the present invention, the cleaning direction of scrapers is perpendicular to the direction of the arrangement of the inkjet openings.

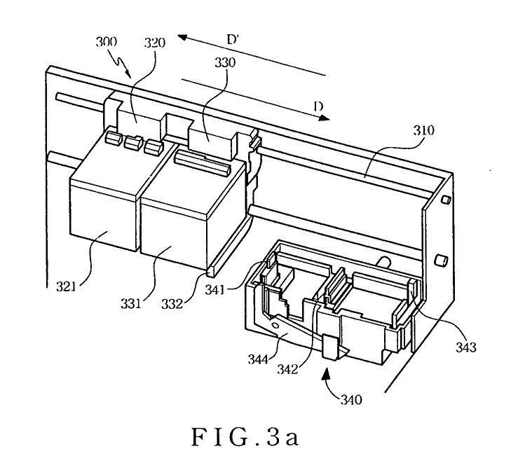

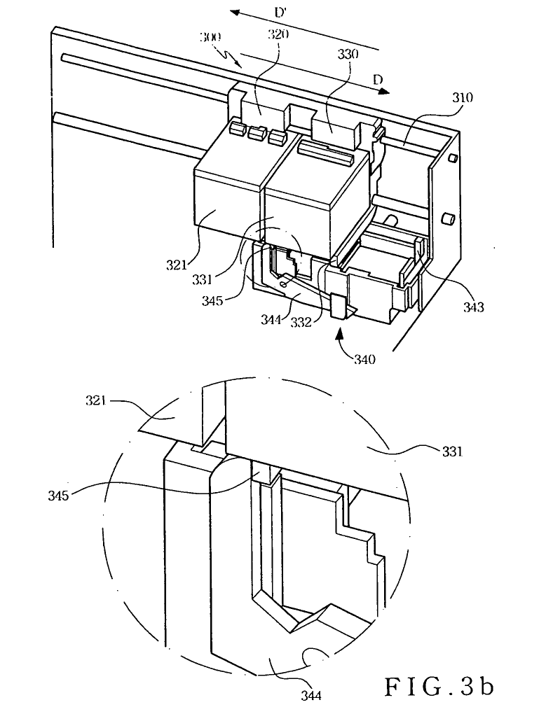

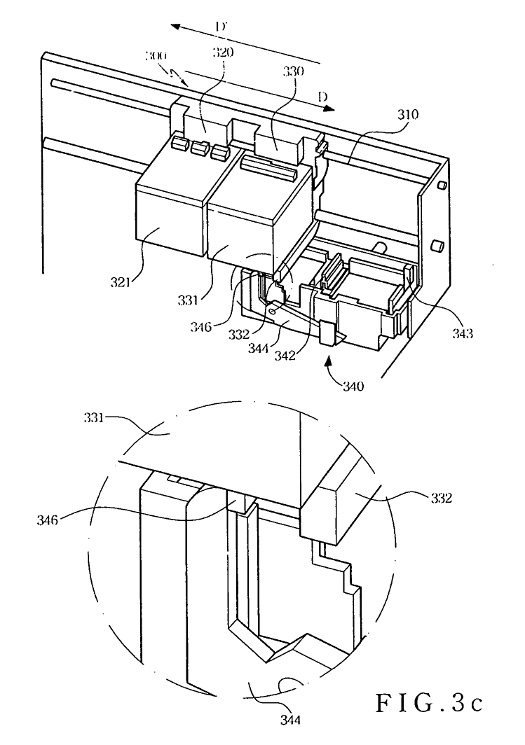

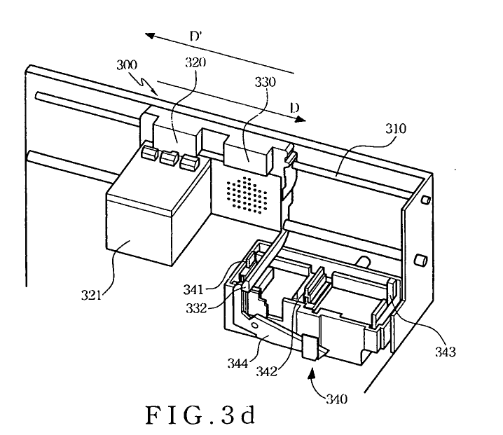

Referring now to FIG. 3a, which illustrates a partial schematic view of a assembly of a printing machine capable of cleaning and protecting the inkjet heads of the present invention. The printing machine includes: a slideway 310, a printing mechanism 300, and a maintaining mechanism 340. Wherein the printing mechanism 300 includes: a first inkjet cartridge 321, a second inkjet cartridge 331, a first container 320, and a second container 330. The maintaining mechanism 340 includes: a first scraper 341, a second scraper 342, a sled 343, and a clutch 344.

The slideway 310 is used to provide a route. The first container 320 accommodates the first inkjet cartridge 321 and slides along the slideway 310. The second container 330 accommodates the second inkjet cartridge 331 and slides along the slideway 310. The first scraper 341 of the maintaining mechanism 340 is used to clean an inkjet head with a first width X1, and the second scraper 342 of the maintaining mechanism 340 is used to clean an inkjet head with a second width X2. The sled 343 respectively connects with the bottoms of the first scraper 341 and the second scraper 342, and elongates below the end of the slideway 310. The first scraper 341 and the second scraper 342 are driven to cleaning position by the driving mechanism 340. The clutch 344 connects with the sled 343 at the outside of the maintaining mechanism 340. The second inkjet cartridge 331 has a driving mechanism 345, 346 (shown in FIG. 3b and FIG. 3c, respectively) so as to drive the sled 343 to control the first scraper 341 and the second scraper 342 to leave the cleaning position.

The first inkjet cartridge 321 and the second inkjet cartridge 331 are set in the printing mechanism 300. Wherein, the first inkjet cartridge 321 has an inkjet head with the first width X1, and the second inkjet cartridge 331 has an inkjet head with the second width X2. The printing mechanism 300 slides in a forward direction D to be above the maintaining mechanism 340. The clutch 344 has a curved surface so as to prevent that the printing mechanism 300 is blocked by the clutch 344 while the printing mechanism 300 moves along the forward direction D. While the printing mechanism 300 slides along the slideway 310 to the end of the route in the forward direction, the second container 330 drives the sled 343, then the sled 343 drives the first scraper 341 and the second scraper 342 to the cleaning position. While the printing mechanism 300 slides in a backward direction D′, the first scraper 341 cleans the inkjet head with the first width X1 of the first inkjet cartridge 321, and the second scraper 342 cleans the inkjet head with the second width X2 of the second inkjet cartridge 331. Then, the driving mechanism 300 drives the clutch 344 so as to control the first scraper 341 and the second scraper 342 to leave the cleaning position and stop cleaning the inkjet heads.

Referring now to FIG. 3b, which illustrates a partial schematic view of a first preferred embodiment of the printing machine of the present invention. The printing machine includes: a slideway 310, a printing mechanism 300, and an maintaining mechanism 340. The structure and moving steps are similar to FIG. 3a, and the difference is that the driving mechanism 345 of the second inkjet cartridge 331 is set at a first position, wherein the first inkjet cartridge 321 still has an inkjet head with the first width X1, and the second inkjet cartridge 331 still has an inkjet head with the second width X2 as well.

While the printing mechanism 300 slides in a backward direction D′, the first scraper 341 cleans the inkjet head with the first width X1 of the first inkjet cartridge 321, and the second scraper 342 cleans the inkjet head with the second width X2 of the second inkjet cartridge 331. Because the driving mechanism 345 of the second inkjet cartridge 331 is set at a first position, the driving mechanism 345 drives the clutch 344 to control the first scraper 341 and the second scraper 342 to leave the cleaning position and stop cleaning the inkjet heads. The relative positions are shown in the magnified view of FIG. 3b.

Referring now to FIG. 3c, which illustrates a partial schematic view of a second preferred embodiment of the printing machine of the present invention. The printing machine includes: a slideway 310, a printing mechanism 300, and an maintaining mechanism 340. The structure and moving steps are similar to FIG. 3a, and the difference is that the driving mechanism 346 of the second inkjet cartridge 331 is set at a second position, wherein the first inkjet cartridge 321 still has an inkjet head with the first width X1, and the second inkjet cartridge 331 still has an inkjet head with the first width X1 as well.

While the printing mechanism 300 slides in a backward direction D′, the first scraper 341 cleans the inkjet head with the first width X1 of the first inkjet cartridge 321, and the second scraper 342 cleans the inkjet head with the first width X1 of the second inkjet cartridge 331. Because the driving mechanism 346 of the second inkjet cartridge 331 is set at a second position, the driving mechanism 346 drives the clutch 344 to control the first scraper 341 and the second scraper 342 to leave the cleaning position and stop cleaning the inkjet heads. The relative position are shown in the magnified view of FIG. 3c.

Referring now to FIG. 3d, which illustrates a partial schematic view of a third preferred embodiment of the printing machine of the present invention. The printing machine includes: a slideway 310, a printing mechanism 300, and an maintaining mechanism 340. The structure and moving steps are similar to FIG. 3a, and the difference is that the second container 330 is not equipped with an inkjet cartridge, wherein the first inkjet cartridge 321 still has an inkjet head with the first width X1.

While the printing mechanism 300 slides in a backward direction D′, the first scraper 341 cleans the inkjet head with the first width X1 of the first inkjet cartridge 321. Because the second container 330 is not equipped with an inkjet cartridge, the edge 332 of the second container 330 drives the clutch 344 to control the first scraper 341 and the second scraper 342 to leave the cleaning position and stop cleaning the inkjet head.

While using two inkjet cartridges and the two inkjet cartridges have different inkjet heads with different widths, respectively, the printing quality may not be affected due to that of different widths and worse cleaning effect via the present invention. The present invention can effectively clean residual of the inkjet heads and decreases the power of a motor as a result of the cleaning direction of scrapers is perpendicular to the direction of the arrangement of the inkjet openings.

While the present invention has been particularly shown and described with reference to a preferred embodiment, it will be understood by those skilled in the art that various changes in form and detail may be without departing from the spirit and scope of the present invention.

I claim:

1. A printing machine used to clean and protect inkjet heads, comprising:
a slideway for providing a route;
a printing mechanism disposed on the slideway, comprising:
a first inkjet cartridge, having a first inkjet head;
a second inkjet cartridge, having a second inkjet head and a driving mechanism;
a first container sliding along the slideway and accommodating the first inkjet cartridge; and
a second container sliding along the slideway and accommodating the second inkjet cartridge; and
a maintaining mechanism disposed on the route, comprising:
a first scraper with a first width;
a second scraper with a second width;
a sled respectively connecting to bottoms of the first scraper and the second scraper, and elongating below an end of the slideway; and
a clutch connecting to the sled;
wherein when said printing mechanism slides along said slideway to the end of the route in a forward direction, said second container drives said sled via said driving mechanism, then said sled drives said first scraper and said second scraper to a cleaning position, when said printing mechanism slides along said slideway in a backward direction, said driving mechanism drives said clutch in order to control said first scraper and said second scraper to leave said cleaning position.

2. The printing machine according to claim 1, wherein said scraper is a cleaning slice.

3. The printing machine according to claim 1, wherein said driving mechanism is a raised lump.

4. The printing machine according to claim 1, wherein when the width of said second inkjet head is equal to said second width, said driving mechanism is disposed at a first position, and after said second scraper cleans said second inkjet head, said driving mechanism then drives said clutch.

5. The printing machine according to claim 1, wherein when the width of said second inkjet head is equal to said first width, said driving mechanism is disposed at a second position, and after said first scraper cleans said first inkjet head and said second inkjet head, said driving mechanism then drives said clutch.

6. The printing machine according to claim 1, wherein when the width of said second inkjet head is equal to said first width, after said first scraper cleans said second inkjet head, said second container then drives said clutch.

7. A maintaining mechanism disposed on a printing machine having a slideway and a printing mechanism, comprising:
a first scraper with a first width;
a second scraper with a second width;
a sled respectively connecting to bottoms of the first scraper and the second scraper and elongating below an end of the slideway; and
a clutch connecting to the sled;
wherein when said printing mechanism slides along said slideway to the end in a forward direction, said printing mechanism drives said sled via a driving mechanism of said printing mechanism, then said sled drives said first scraper and said second scraper to a cleaning position, when said printing mechanism slides along said slideway in a backward direction, said driving mechanism drives said clutch in order to control said first scraper and said second scraper to leave said cleaning position.

8. The maintaining mechanism according to claim 7, wherein said scraper is a cleaning slice.

9. The maintaining mechanism according to claim 7, wherein said driving mechanism is a raised lump.

10. The maintaining mechanism according to claim 7, wherein said printing mechanism further comprises a first and a second inkjet heads, when the width of said second inkjet head is equal to said second width, said driving mechanism is disposed at a first position, and after said second scraper cleans said second inkjet head, said driving mechanism then drives said clutch.

11. The maintaining mechanism according to claim 7, wherein said printing mechanism further comprises a first and a second inkjet heads, when the width of said second inkjet head is equal to said first width, said driving mechanism is disposed at a second position, and after said first scraper cleans said first inkjet head and said second inkjet head, said driving mechanism then drives said clutch.

12. The maintaining mechanism according to claim 7, wherein said printing mechanism further comprises a first and a second inkjet heads, when the width of said second inkjet head is equal to said first width, after said first scraper cleans said second inkjet head, said second container then drives said clutch.

13. A cleaning method of using a maintaining mechanism to clean an inkjet head of a printing mechanism, wherein the maintaining mechanism comprises a first scraper, whose width corresponds to the width of a first inkjet head, a second scraper, whose width corresponds to the width of a second inkjet head, a sled, and a clutch, the method comprising the steps of:
driving the printing mechanism sliding along a forward direction to be above the maintaining mechanism, and driving the sled to control the first scraper and the second scraper to move to a cleaning position;
driving the printing mechanism sliding along a backward direction, wherein the first scraper cleans the first inkjet head and the second scraper cleans the second inkjet head, respectively; and
utilizing the sled to control the first scraper and the second scraper to leave the cleaning position by driving the clutch.

14. The cleaning method according to claim 13, wherein a contact surface of said clutch contacting said printing mechanism along said forward direction is a curved surface so as to prevent that said printing mechanism is blocked by said clutch while said printing mechanism moves along said forward direction.

15. The cleaning method according to claim 13, wherein said printing mechanism further comprises a second container for accommodating said second inkjet head, when said second container moves to the end along said forward direction in order to drive said sled to move said first scraper and said second scraper to said cleaning position.

16. The cleaning method according to claim 13, wherein said printing mechanism further comprises a driving mechanism, and said printing mechanism drives said clutch via said driving mechanism in order to make that said sled drives said first scraper and said second scraper to leave said cleaning position.

17. The cleaning method according to claim 16, wherein said driving mechanism of said printing mechanism is disposed at a first position to drive said clutch controlling said first and second scrapers for stopping cleaning after said second scraper cleans said second inkjet head.
